(19) United States
(12) Patent Application Publication
(10) Pub. No.: US 2017/0183266 A1
(43) Pub. Date: Jun. 29, 2017

(54) CERAMIC STRUCTURES

(71) Applicant: Imerys, Paris (FR)

(72) Inventors: Marcia CORREIA GOMES, Paris (FR); Magdalena GONZÁLEZ CASTRO, Paris (FR); Marc PRÉVOT, Paris (FR); Pascual CIA-PÉRÉZ, Guarda (Pontevedra) (ES); Jean-Paul GIRAUD, Neuvy (FR); Jean André ALARY, L'lsle sur la Sorgue (FR)

(21) Appl. No.: 15/129,647

(22) PCT Filed: Mar. 27, 2015
(86) PCT No.: PCT/EP2015/056788

§ 371 Date: Sep. 27, 2016

(30) Foreign Application Priority Data
Mar. 28, 2014 (EP) 14290082.8

(51) Int. Cl. C04B 35/478; F01N 3/022; B01D 46/24; C04B 35/64; C04B 38/00

(52) U.S. Cl. CPC C04B 35/478; C04B 35/64; C04B 38/0006; C04B 38/0012; B01D 46/2418; F01N 3/0222; C04B 2235/3463; C04B 2235/3222; C04B 2235/3234; C04B 2235/3249; C04B 2235/6021; C04B 2235/606; C04B 2235/656; C04B 2235/9607; B01D 2279/30

(57) ABSTRACT

A ceramic composition, optionally in the form of a honeycomb structure, ceramic precursor compositions suitable for sintering to form said ceramic composition, a method for preparing said ceramic composition and ceramic honeycomb structure, a diesel particulate filter comprising said ceramic honeycomb structure, and a vehicle comprising said diesel particulate filter.

The present application is directed to a ceramic composition, optionally in the form of a honeycomb structure, to ceramic precursor compositions suitable for sintering to form said ceramic composition, to a method for preparing said ceramic composition and ceramic honeycomb structure, to a diesel particulate filter comprising said ceramic honeycomb structure, and to a vehicle comprising said diesel particulate filter.

### BACKGROUND OF THE INVENTION

Ceramic structures, particularly ceramic honeycomb structures, are known in the art for the manufacture of filters for liquid and gaseous media. The most relevant application today is in the use of such ceramic structures as particle filters for the removal of fine particles from the exhaust gas of diesel engines of vehicles (diesel particulates), since those fine particulates have been shown to have negative influence on human health.

The ceramic material has to fulfil several requirements. First, the material should have sufficient filtering efficiency, i.e., the exhaust gas passing the filter should be substantially free of diesel particulates, but the filter should not produce a substantial pressure drop, i.e., it must show a sufficient ability to let the exhaust gas stream pass through its walls. These parameters generally depend upon the wall parameters (thickness, porosity, pore size, etc.) of the filter.

Second, the material must show sufficient chemical resistance against the compounds in exhaust gas of diesel engines over a broad temperature range.

Third, the material must be resistant against thermal shock due to the high temperature differences that apply during its life cycle. Thus, the material should have a low coefficient of thermal expansion to avoid mechanical tensions during heating and cooling periods particularly for monolithic honeycombs.

Fourth, the material must have a melting point above the temperatures reached (typically >1000° C.) within the filter during a regeneration cycle.

Fifth, the ceramic material should have favourable high temperature properties as during use (as a diesel filer) and regeneration the ceramic material will be exposed to high temperatures.

If the above requirements are not fulfilled, mechanical and/or thermal tension may cause cracks in the ceramic material, resulting in decrease of filter efficiency or even filter failure.

Further, since the filters for vehicles are produced in high numbers, the ceramic material should be relatively inexpensive, and the process for its manufacture should be cost-effective.

A summary on the ceramic materials known for this application is given in the paper of J. Adler, Int. J. Appl. Ceram. Technol. 2005, 2(6), p 429-439, the content of which is incorporated herein in its entirety for all purposes.

Several ceramic materials have been described for the manufacture of ceramic honeycomb filters suitable for that specific application.

For example, honeycombs made from ceramic materials based on mullite and tialite have been used for the construction of diesel particulate filters. Mullite is an aluminium and silicon containing silicate mineral of variable composition between the two defined phases [3Al₂O₃.2SiO₂] (the so-called “stoichiometric” mullite or “3:2 mullite”) and [2Al₂O₃.1SiO₂] (the so-called “2:1 mullite”). The material is known to have a high melting point, refractoriness and fair mechanical properties. Tialite is an aluminium titanate having the formula [Al₂Ti₂O₅]. The material is known to show a high thermal shock resistance, low thermal expansion and a high melting point.

Owing to these properties, tialite has traditionally been a favoured material of choice for the manufacture of honeycomb structures. For example, US-A-20070063398 describes porous bodies for use as particulate filters comprising over 90% tialite. Similarly, US-A-20100230870 describes ceramic bodies suitable for use as particulate filters having an aluminium titanate content of over 90 mass %.

Attempts have also been made to combine the positive properties of mullite and tialite, e.g., by developing ceramic materials comprising both phases.

WO-A-2009/076985 describes a ceramic honeycomb structure comprising a mineral phase of mullite and a mineral phase of tialite. The examples describe a variety of ceramic structures typically comprising at least about 65 vol. % mullite and less than 15 vol. % tialite.

There is a need in the art for new ceramic filter materials showing properties comparable to or improved over those of the prior art.

### SUMMARY OF THE INVENTION

In accordance with a first aspect of the present invention, there is provided a ceramic composition comprising: from about 15 wt. % to less than about 50 wt. % mullite; from about 40 wt. % to about 75 wt. % tialite; and at least about 1.0 wt. % of a Zr-containing mineral phase, for example, at least about 1.5 wt. % of a Zr-containing mineral phase. The weight ratio of tialite to mullite is greater than 1:1, and the ceramic composition has a coefficient of thermal expansion (CTE) of equal to or less than about 1.5×10⁻⁶° C.⁻¹, and a thermal strength parameter (TSP) of at least about 150° C.

In accordance with a second aspect of the present invention, there is provided a ceramic composition according to the first aspect of the present invention in the form of a honeycomb structure.

In accordance with a third aspect of the present invention, there is provided a ceramic precursor composition suitable for sintering to form a ceramic composition according to to the first aspect of the present invention, said precursor composition comprising: mullite and/or one or more mullite-forming compounds or compositions; tialite and/or one or more tialite-forming compounds or compositions; and Zr-containing mineral phase and/or one or more Zr-containing mineral phase-forming compounds or compositions.

In accordance with a fourth aspect of the present invention, there is provided a method for making a honeycomb structure according to the second aspect of the present invention, said method comprising: (a) providing a dried green honeycomb structure formed from the ceramic precursor composition according to third aspect of the present invention; and (b) sintering.

In accordance with a fifth aspect of the present invention, there is provided a diesel particulate filter comprising or made from the ceramic honeycomb structure according to second aspect of the present invention or obtainable by the method of according to the third fourth aspect of the present invention.

In accordance with a sixth aspect of the present invention, there is provided a vehicle having a diesel engine and a filtration system comprising the diesel particulate filer according to the fifth aspect of the present invention.

### BRIEF DESCRIPTION OF THE DRAWINGS

FIG. 1 is a graph summarizing a thermomechanical property of a ceramic honeycomb structure prepared in accordance with the present invention and a comparative ceramic honeycomb structure.

### DETAILED DESCRIPTION OF THE INVENTION

The amounts of tialite, mullite and other mineral phases in the ceramic composition or ceramic honeycomb structure may be measured using qualitative X-ray diffraction (Cu Kα radiation, 40 KV, 30 mA, Rietveld analysis with a 30 wt. % ZnO standard), or any other measurement method which gives an equivalent result. As will be understood by the skilled person, in the X-ray diffraction method, the sample is milled. After milling, the powder is homogenized, and then filled into the sample holder of the X-ray diffractometer. The powder is pressed into the holder and any overlapping powder is removed to ensure an even surface. After placing the sample holder containing the sample into the X-ray diffractometer, the measurement is started. Typical measurement conditions are a step width of 0.015°, a measurement time of 2 seconds per step and a measurement range from 10 to 60° 20. The resulting diffraction pattern is used for the quantification of the different phases, which the sample material consists of, by using appropriate software capable of Rietveld refinement. A suitable diffractometer is a SIEMENS D5000, and suitable Rietveld software is BRUKER AXS DIFFRAC^{plus} TOPAS. The amount of each mineral phase in the ceramic composition, e.g., ceramic honeycomb structure, is expressed as a weight % based on the total weight of the mineral phases.

Unless otherwise stated, the particle size properties referred to herein for the mineral starting material are as measured by the well known conventional method employed in the art of laser light scattering, using a Malvern Mastersizer 2000 machine as supplied by Malvern Instruments Ltd (or by other methods which give essentially the same result). In the laser light scattering technique, the size of particles in powders, suspensions and emulsions may be measured using the diffraction of a laser beam, based on an application of Mie theory. Such a machine provides measurements and a plot of the cumulative percentage by volume of particles having a size, referred to in the art as the ‘equivalent spherical diameter’ (e.s.d), less than given e.s.d values. The mean particle size d₅₀ is the value determined in this way of the particle e.s.d at which there are 50% by volume of the particles which have an equivalent spherical diameter less than that d₅₀ value. The d₁₀ and d₉₀ are to be understood in similar fashion.

Unless otherwise stated, in each case, the lower limit of a range is the d₁₀ value and the upper limit of the range is the d₉₀ value.

In the case of colloidal titania, the particle size is measured using transmission electron microscopy.

Unless otherwise stated, the measurement of the particle sizes of components which are present in the sintered ceramic composition or honeycomb structure in a particulate form may be accomplished by image analysis.

In embodiments, the ceramic composition, e.g., ceramic honeycomb structure, comprises (on a weight % basis):
15-59%, or 19-49%, or 22-49%, or 25-49%, or 19-48%, or 25-48%, or 30-48%, or 22-47%, or 25-47%, or 30-47%, or 35-47%, or 35-46%, or 35-45%, or 36-45%, or 37-45%, or 37-44%, or 37-43%; or 35-43%, or 35-42%, or 35-41%, or 35-40%, or 40-48%, or 40-45% mullite;
40-75%, or 40-72%, or 40-70%, or 40-68%, or 40-66%, or 40-64%, or 40-62%, or 40-60%, or 42-60%, or 44-60%, or 44-58%, or 44-56%, or 44-54%, or 44-52%, or 44-50%, or 45-50%, or 50-65%, or 50-60%, or 55-65%, or 50-55%, or 45-55% tialite;
1.0-8.0%, or 1.5-8.0%, or 2.0-8.0%, or 2.5-8.0%, or 3.0-8.0%, or 3.0-7.0%, or 3.5-7.0%, or 3.5-6.5%, or 3.5-6.0%, or 3.5-5.5%, or 4.0-6.0%, or 4.0-5.0% of Zr-containing mineral phase;
0-10%, or 0-5, or 0-3%, or 0-2%, or 0-1% of an amorphous phase;
0-10%, or 0.5-8%, or 0.5-7%, or 1.0-6.0%, or 1.5-5.5%, 2.0-5.0%, or 2.5-5.0%, or 3.0-5.0%, or 3.5-5.0% of alkaline earth metal-containing mineral phase; and
0-10%, or 0-7%, or 0-5%, or 0-4%, or 0-3%, or 0-2%, or 0-1% alumina.

In embodiments, the ceramic composition, e.g., ceramic honeycomb structure, comprises (on a weight % basis):
15-44%, or 19-42%, or 22-40%, or 25-38%, or 19-35%, or 25-35%, or 30-40%, or 15-35%, or 15-32%, or 15-30% mullite;
56-75%, or 58-72%, or 60-72%, or 60-70%, or 62-72%, or 64-72%, or 64-70% tialite;
1.0-8.0%, or 1.5-8.0%, or 1.5-7.0%, or 2.0-6.0%, or 2.0-5.0%, or 2.0-4.0%, 2.0-3.5%, or 2.0-3.0% of Zr-containing mineral phase;
0-10%, or 0-5, or 0-3%, or 0-2%, or 0-1% of an amorphous phase;
0-10%, or 0.5-8%, or 0.5-7%, or 1.0-6.0%, 1.0-4.0%, or 1.0-3.0, or 1.0-2.5%, or 1.0-2.0%, of alkaline earth metal-containing mineral phase; and
0-10%, or 0-7%, or 0-5%, or 0-4%, or 0-3%, or 0-2%, or 0-1% alumina.

In certain embodiments, the ceramic composition comprises up to about 45 wt. % mullite and greater than about 45 wt. % tialite, for example, up to about 44 wt. % mullite, or up to about 43 wt. % mullite, or up to about 42 wt. % mullite, or up to about 41 wt. % mullite, or up to about 40 wt. % mullite. In certain embodiments, the ceramic composition comprises at least about 46 wt. % tialite, or at least about 47 wt. % tialite, or at least about 48 wt. % tialite, or at least about 49 wt. % tialite, or at least about 50 wt. % tialite.

In certain embodiments, the ceramic composition comprises greater than about 45 wt. % tialite.

In certain embodiments, the ceramic composition comprises equal to or greater than about 50 wt. % tialite.

In certain embodiments, the ceramic composition comprises equal to or greater than about 60 wt. % tialite.

In certain embodiments, the ceramic composition comprises equal to or greater than about 65 wt. % tialite.

In certain embodiments, the weight ratio of tialite to mullite is equal to or greater than about 1.1:1, for example, equal to or greater than about 1.2:1, or equal to or greater than about 1.3:1, or equal to or greater than about 1.4:1, or equal to or greater than about 1.5:1, or equal to or greater than about 1.6:1, or equal to or greater than about 1.7:1, or equal to or greater than about 1.9:1, or equal to or greater than about 2.0:1, or equal to or greater than about 2.1:1, or equal to or greater than about 2.2:1, or equal to or greater than about 2.3:1, or equal to or greater than about 2.4:1, or equal to or greater than about 2.5:1. In certain embodiments, the weight ratio of tialite to mullite is less than about 3.8:1, for example, equal to or less than about 3.6:1, or equal to or less than about 3.4:1, or equal to or less than about 3.2:1, or equal to or less than about 3.0:1, or equal to or less than about 2.9:1, or equal to or less than about 2.8:1, or equal to or less than about 2.7:1, or equal to or less than about 2.6:1. In certain embodiments, the weight ratio of tialite to mullite is from about 1.1:1 to less than about 3:1, for example, from about 1.1:1 to equal to or less than about 2.8:1, or from about 1.1:1 to equal to or less than about 2.6:1.

In certain embodiments, the mullite and tialite mineral phases constitute at least about 80 wt. % of the total weight of the mineral phases, for example, at least about 85 wt. % of the total weight of the mineral phases, or at least about 88 wt. %, or at least about 90 wt. %, or at least about 92 wt. %, or at least about 94 wt. % of total weight of the mineral phases. In certain embodiments, the mullite and tialite mineral phases constitute up to about 98.5 wt. % of the mineral phases, for example, up to about 98.0 wt. % of the mineral phases, or up to about 97.5% of the mineral phases, or up to about 97.0% of the mineral phases, or up to about 96.5% of the mineral phases, or up to about 96.0% of the mineral phases, or up to about 95.5% of the mineral phases, or up to about 95.0% of the mineral phases.

In certain embodiments, the ceramic composition comprises from about 1.0-8.0% of Zr-containing mineral phase, for example, from about 1.5-8.0%, or about 2.0-8.0%, or about 2.5-8.0%, or about 3.0-8.0%, or about 3.0-7.0%, or about 3.5-7.0%, or about 3.5-6.5%, or about 3.5-6.0%, or about 3.5-5.5%, or about 4.0-6.0%, or about 4.0-5.0% of Zr-containing mineral phase. In such embodiments, the ceramic composition may further comprise from about 0.5-3.0 wt. % of alkaline earth metal-containing mineral phase, for example, from about 0.5-2.5 wt. %, or about 1.0-2.5 wt. %, or about 1.0-2.0 wt. %, or about 1.0-1.5 wt. % of alkaline earth metal-containing mineral phase.

In certain embodiments, for example, embodiments in which the ceramic composition comprises at least about 56 wt. % tialite, or at least about 60.0 wt. % tialite, the ceramic composition comprises from about 1.0-8.0 wt. % of Zr-containing mineral phase, for example, from about 1.5-8.0 wt. %, or about 1.5-5.0 wt. %, or about 1.5-4.0 wt. %, or about 2.0-4.0 wt. %, or about 2.0-3.5 wt. %, or about 2.0-3.0 wt. % of Zr-containing mineral phase; In such embodiments, the ceramic composition may further comprise from about 0.5-3.0 wt. % of alkaline earth metal-containing mineral phase, for example, from about 0.5-2.5 wt. %, or about 1.0-2.5 wt. %, or about 1.0-2.0 wt. %, or about 1.0-1.5 wt. % of alkaline earth metal-containing mineral phase.

In certain embodiments, the ceramic composition comprises at least about 1.0 wt. % of Zr-containing mineral phase.

In certain embodiments, the ceramic composition comprises at least about 3.0 wt. % of Zr-containing mineral phase.

In certain embodiments, the ceramic composition comprises at least about 3.5 wt. % of Zr-containing mineral phase.

In certain embodiments, the ceramic composition comprises at least about 4.0 wt. % of Zr-containing mineral phase.

In certain embodiments, the ceramic composition comprises at least about 4.5 wt. % of Zr-containing mineral phase.

In certain embodiments, the ceramic composition comprises at least about 4.5 wt. % of Zr-containing mineral phase.

In the embodiments described above, the ceramic composition typically comprises no more than about 8.0 wt. % Zr-containing mineral phase, for example, no more than about 7.0 wt. % Zr-containing mineral phase, or no more than about 6.5 wt. % Zr-containing mineral phase, or no more than about 6.0 wt. % Zr-containing mineral phase

The ceramic composition, e.g., ceramic honeycomb structure, of any of the above embodiments has a coefficient of thermal expansion (CTE) of equal to or less than about 1.5×10⁻⁶° C.⁻¹, as measured at 800° C. by dilatometry according to DIN 51045 using a Dilatometer Adamel Lhomargy—model DI-24, and a sample length of 40 mm+/−5 mm. In certain embodiments, the CTE may be equal to or less than about 1.4×10⁻⁶° C.⁻¹, for example, equal to or less than about 1.3×10⁻⁶° C.⁻¹, or equal to or less than about 2.5×10⁻⁶° C.⁻¹, or equal to or less than about 1.2×0⁻⁶° C.⁻¹.

In certain embodiments, the ceramic composition, e.g., ceramic honeycomb structure, has a CTE of equal to or less than about 1.1×10⁻⁶° C.⁻¹, or equal to or less than about 1.0×10⁻⁶° C.⁻¹, equal to or less than about 0.9×10⁻⁶° C.⁻¹, or equal to or less than about 0.8×10⁻⁶° C.⁻¹, or equal to or less than about 0.7×10⁻⁶° C.⁻¹ or equal to or less than about 0.6×10⁻⁶° C.⁻¹. Typically, the CTE will be greater than about 0.1×10⁻⁶° C.⁻¹, for example, greater than about 0.2×10⁻⁶° C.⁻¹, or greater than about 0.3×10⁻⁶° C.⁻¹.

The thermal strength parameter (TSP) of the ceramic composition is determined in accordance with the following equation:

TSP=[MOR/(CTE×Young's Modulus)] (1)

MOR is the modulus of rupture (MOR) of the ceramic composition, e.g., ceramic honeycomb structure, as measured in accordance with ASTM C 1674-08 (Standard Test Method for Flexural Strength of Advanced Ceramics with Engineered Porosity (Honeycomb Cellular Channels at Ambient Temperature). MOR is measured following Test Method B (see section 1.3.2 of ASTM C 1674-08) and it was a 4-point bending test. In the test method a test specimen rests on two supports and is loaded by means of a loading roller midway between the two outer supports. The press equipment was Model MEM-102/M3 available from Suzpecar.

The Young's modulus is determined in accordance with DIN EN 843-2:2007 using Pundit Plus ultra sound equipment (Reference E0646) available from Controlab. The test sample is a honeycomb sample cut with dimensions of 55 mm×55 mm+/−10 mm. The measurement is made in the longitudinal channels direction (with 82 KHz transducers with diameter 33 mm) with a resolution of greater than 0.1 μs.

In certain embodiments, the ceramic composition, e.g., ceramic honeycomb structure has a TSP of at least about 175° C., for example, at least about 200° C., or at least about 210° C., or at least about 220° C., or at least about 230° C., or at least about 240° C., or at least about 250° C. In certain embodiments, the ceramic composition, e.g., ceramic honeycomb structure has a TSP of from about 150° C. to about 350° C., for example, from about 150° C. to about 275° C., or from about 175° C. to about 250° C., or from about 200° C. to about 250° C.

In certain embodiments, the ceramic composition, e.g., ceramic honeycomb structure, has a MOR of from about 0.5 MPa to about 10 MPa and a Young's Modulus of from about 5 GPa to about 25 GPa, with the proviso that the MOR and Young's Modulus are such that a TSP calculated in accordance with equation (1) is at least 150° C.

The ceramic composition and ceramic honeycomb structure of any of the above embodiments may have a MOR of from about 0.5 MPa to about 8 MPa, or from about 1.0 to about 6 MPa, or from about 1.25 to about 5 MPa, or from about 1.5 MPa to about 5 MPa, or from about 0.5 MPa to about 4 MPa, or from about 0.5 MPa to about 3. MPa, or from about 0.5 MPa to about 2 MPa.

The ceramic composition and ceramic honeycomb structure of any of the above embodiments may have a Young's Modulus of at least about 5 GPa. In certain embodiments, the Young's Modulus may be between about 5 and 25 GPa, for example, equal to or less than about 22 GPa, or equal to or less than about 20 GPa, or equal to or less than about 18 GPa, or equal to or less than about 16 GPa, or equal to or less than about 14 GPa. In certain embodiments, the Young's Modulus may be from about 5 GPa to about 15 GPa, for example, from about 6 GPa to about 12 GPa, or from about 6 GPa to about 10 GPa.

In certain embodiments, the ceramic composition comprises greater than about 45 wt. % tialite, no more than about 44 wt. % mullite, from about 1.0-8.0 wt. % Zr-containing mineral phase, for example, from about 1.5-8.0 wt. % Zr-containing mineral phase, has a CTE of equal to or less than about 1.5×10⁻⁶° C.⁻¹, and a TSP of greater than about 150° C. In such embodiments, the ceramic composition may further comprise from about 0.5-3.0 wt. % of alkaline earth metal-containing mineral phase, for example, from about 0.5-2.5 wt. %, or about 1.0-2.5 wt. %, or about 1.0-2.0 wt. %, or about 1.0-1.5 wt. % of alkaline earth metal-containing mineral phase.

In certain embodiments, the ceramic composition comprises greater than about 46 wt. % tialite, no more than about 44 wt. % mullite, from about 1.0-8.0 wt. % Zr-containing mineral phase, for example, from about 3.0-8.0 wt. % Zr-containing mineral phase, has a CTE of equal to or less than about 1.1×10⁻⁶° C.⁻¹, and a TSP of greater than about 150° C., for example, a TSP of equal to or greater than about 200° C. In such embodiments, the ceramic composition may further comprise from about 0.5-3.0 wt. % of alkaline earth metal-containing mineral phase, for example, from about 0.5-2.5 wt. %, or about 1.0-2.5 wt. %, or about 1.0-2.0 wt. %, or about 1.0-1.5 wt. % of alkaline earth metal-containing mineral phase.

In certain embodiments, the ceramic composition comprises greater than about 47 wt. % tialite, no more than about 44 wt. % mullite, from about 1.0-8.0 wt. % Zr-containing mineral phase, for example, from about 4.0-8.0 wt. % Zr-containing mineral phase, has a CTE of equal to or less than about 1.0×10⁻⁶° C.⁻¹, and a TSP of equal to or greater than about 200° C. In such embodiments, the ceramic composition may further comprise from about 0.5-3.0 wt. % of alkaline earth metal-containing mineral phase, for example, from about 0.5-2.5 wt. %, or about 1.0-2.5 wt. %, or about 1.0-2.0 wt. %, or about 1.0-1.5 wt. % of alkaline earth metal-containing mineral phase.

In certain embodiments, the ceramic composition comprises greater than about 47 wt. % tialite, no more than about 44 wt. % mullite, from about 5.0-8.0 wt. % Zr-containing mineral phase, has a CTE of less than about 1.0×10⁻⁶° C.⁻¹, and a TSP of equal to or greater than about 220° C. In such embodiments, the ceramic composition may further comprise from about 0.5-3.0 wt. % of alkaline earth metal-containing mineral phase, for example, from about 0.5-2.5 wt. %, or about 1.0-2.5 wt. %, or about 1.0-2.0 wt. %, or about 1.0-1.5 wt. % of alkaline earth metal-containing mineral phase. In such embodiments, the ceramic composition may further comprise from about 0.5-3.0 wt. % of alkaline earth metal-containing mineral phase, for example, from about 0.5-2.5 wt. %, or about 1.0-2.5 wt. %, or about 1.0-2.0 wt. %, or about 1.0-1.5 wt. % of alkaline earth metal-containing mineral phase.

In certain embodiments, the ceramic composition comprises greater than about 50 wt. % tialite, no more than about 44 wt. % mullite, from about 3.0-8.0 wt. % Zr-containing mineral phase, has a CTE of less than about 1.5×10⁻⁶° C.⁻¹, and a TSP of equal to or greater than about 150° C., for example, a TSP of equal to or greater than about 175° C. In such embodiments, the ceramic composition may further comprise from about 0.5-3.0 wt. % of alkaline earth metal-containing mineral phase, for example, from about 0.5-2.5 wt. %, or about 1.0-2.5 wt. %, or about 1.0-2.0 wt. %, or about 1.0-1.5 wt. % of alkaline earth metal-containing mineral phase. Advantageously, the alkaline earth metal-containing mineral phase is a Mg-containing mineral phase.

In certain embodiments, the ceramic composition comprises from about 60 wt. % to 75 wt. % tialite, e.g., from about 60 wt. % to about 70 Wt. % tialite, from about 1.0-8.0 wt. % Zr-containing mineral phase, for example, from about 1.5-8.0 wt. % Zr-containing mineral phase, has a CTE of equal to or less than about 1.1×10⁻⁶° C.⁻¹, and a TSP of greater than about 150° C., for example, a TSP of equal to or greater than about 175° C.

In certain embodiments, the ceramic composition comprises from about 65 wt. % to 70 wt. % tialite, from about 1.5.0-5.0 wt. % Zr-containing mineral phase, for example, from about 1.5-4.0 wt. % Zr-containing mineral phase, has a CTE of equal to or less than about 1.0×10⁻⁶° C.⁻¹, and a TSP of greater than about 150° C., for example, a TSP of equal to or greater than about 175° C.

In certain embodiments, the ceramic composition comprises from about 60 wt. % to 75 wt. % tialite, for example, from about 60 wt. % to about 70 wt. % tialite, from about 1.5-8.0 wt. % Zr-containing mineral phase, for example, from about 1.5-5.0 wt. % Zr-containing mineral phase, or from about 1.5-3.5 wt. % Zr-containing mineral phase, has a CTE of equal to or less than about 1.0×10⁻⁶° C.⁻¹, and a TSP of greater than about 150° C., for example, a TSP of equal to or greater than about 200° C. In certain embodiments, the ceramic composition has a CTE of equal to or less than about 0.9×10⁻⁶° C.⁻¹, or equal to or less than about 0.8×10⁻⁶° C.⁻¹, equal to or less than about 0.7×10⁻⁶° C.⁻¹, equal to or less than about 0.6×10⁻⁶° C.⁻¹.

In certain embodiments, Zr-containing mineral phase comprises ZrO (i.e., zirconia). In certain embodiments, the Zr-containing mineral phase comprises zirconium titanate. In certain embodiments, the Zr-containing mineral phase comprises ZrO and zirconium titanate. In certain embodiments, zirconium titanate has the chemical formula Tiₓ Zr₁₋ₓO₂, wherein x is from 0.1 to about 0.9, for example, greater than about 0.5. In embodiments, the Zr-containing mineral phase comprise a mixture of ZrO₂ and Tiₓ Zr₁₋ₓO₂.

In certain embodiments, at least about 10 wt. % of the Zr-containing mineral phase is zirconium titanate, as may be determined in accordance with the XRD method described above. In certain embodiments, at least about 20 wt. % of the Zr-containing mineral phase is zirconium titanate, for example, at least about 30 wt. % of the Zr-containing mineral phase is zirconium titanate, or at least about 40 wt. % of the Zr-containing mineral phase is zirconium titanate, or at least about 50 wt. % of the Zr-containing mineral phase is zirconium titanate.

In certain embodiments, the ceramic composition comprises from about 1.0-6.0 wt. % of alkaline earth metal-containing mineral phase, for example, from about 1.0-5.0%, or from about 1.0-4.0 wt. %, or from about 1.0-3.5 wt. %, or from about 1.0-3.0 wt. %, or 1.0-2.5 wt. %, or from about 1.0-2.0 wt. % of alkaline earth metal-containing mineral phase. The alkaline earth metal may be selected from Mg, Ca and Ba, or mixtures thereof. In certain embodiments, the alkaline earth metal is Mg.

In embodiments in which the alkaline earth metal is Mg, the Mg-containing mineral phase may comprise MgO and/or magnesium titanate.

In certain embodiments, the total amount of Zr-containing mineral phase and Mg-containing mineral phase constitutes from about 1.0-8.0 wt. % of the ceramic composition, e.g., ceramic honeycomb structure, for example, from about 1.5-8.0 wt. %, of from about 2.5-7.5 wt. %, or from about 3.0-6.5 wt. %, or from about 3.5-6.0 wt. %, or from about 4.0-6.0 wt. %, or from about 4.5-6.0 wt. %, or from about 5.0-6.0 wt. % of the ceramic composition. In such embodiments, the weight ratio of Zr-containing mineral phase and Mg-containing mineral phase may be at least about 1.25:1, for example, at least about 1.5:1, or at least about 1.75:1, or at least about 2:1. Typically, the weight ratio of Zr-containing mineral phase and Mg-containing mineral phase is no more than about 5:1, for example, no more than about 4:1, or no more than about 3:1.

Conventional wisdom in the art is that as the tialite content of a tialite-mullite ceramic increases, the MOR of the ceramic would be expected to decrease, and thus, following equation (1), so would the TSP. However, the present inventors have surprisingly found that the presence of a relatively small (relative to the tialite and mullite content) amount of a Zr-containing mineral phase and optionally an alkaline earth metal-containing mineral phase, can offset, at least partially, the decrease in MOR, and thus, TSP. Without wishing to be bound by theory, it is believed that the crystalline structure of the Zr-containing mineral phase, e.g., Zr titanate adopting a perovskite-type structure, has a beneficial effect on the strength properties of the ceramic composition. Further, the present inventors have surprisingly found that the presence of a relatively small amount of a Zr-containing mineral phase and optionally an alkaline earth metal-containing mineral phase has a beneficial effect in lowering the CTE of a tialite-mullite ceramic comprising more tialite than mullite. Again, without wishing to be bound by theory, it is believed that the crystalline structure of the Zr-containing mineral phase, e.g., Zr titanate adopting a perovskite-type structure, is able to “absorb” the impact of structural expansion at increased temperatures, meaning that the CTE of the tialite-mullite ceramic comprising the Zr-containing mineral phase is lower that it would have been without the Zr-containing mineral phase. From equation (1) it is seen that a lower CTE will lead to a higher TSP.

In certain embodiments, the ceramic composition is substantially free of alumina mineral phases and/or aluminosilicate mineral phases and/or titania mineral phases and/or an amorphous phase.

As used herein, the term “substantially free” refers to the total absence of or near total absence of a specific compound or composition or mineral phase. For example, when the ceramic composition is said to be substantially free of alumina, there is either no alumina in the ceramic composition or only trace amounts of alumina in the composition. A person skilled in the art will understand that a trace amount is an amount which may be detectable by the XRD method described above, but not quantifiable and moreover, if present, would not adversely affect the properties of the ceramic composition or ceramic honeycomb structure.

The amorphous phase may comprise, consist essentially of, or consist of a glassy silica phase. The glassy silica phase may form from decomposition of aluminosilicate, for example, andalusite, during mullitization, typically at sintering temperatures between about 1300° C. and 1600° C.

In an embodiment, the amount of iron in the ceramic composition or ceramic honeycomb structure, measured as Fe₂O₃, is less than 5% by weight, and for example may be less than about 2 wt. %, or for example less than about 1 wt. %, or for example less than about 0.75 wt. %, or for example less than about 0.50 wt. %, or for example less than about 0.25 wt. %. The structure may be essentially free from iron, as may be achieved for example by using starting materials which are essentially free of iron. Iron content, measured as Fe₂O₃, may be measured by XRF.

In an embodiment, the amount of strontium, measured as SrO, is less than about 2 wt. %, and for example less than about 1 wt. %, or for example less than about 0.75 wt. %, or for example less than about 0.50 wt. %, or for example less than about 0.25 wt. %. The structure may be essentially free from strontium, as may be achieved for example by using starting materials which are essentially free of strontium. Strontium content, measured as SrO₂, may be measured by XRF.

In an embodiment, the amount of chromium, measured as Cr₂O₃, is less than about 2 wt. %, and for example less than about 1 wt. %, or for example less than about 0.75 wt. %, or for example less than about 0.50 wt. %, or for example less than about 0.25 wt. %. The structure may be essentially free from chromium, as may be achieved for example by using starting materials which are essentially free of chromium. Chromium content, measured as Cr₂O₃, may be measured by XRF.

In an embodiment, the amount of tungsten, measured as W₂O₃, is less than about 2 wt. %, and for example less than about 1 wt. %, or for example less than about 0.75 wt. %, or for example less than about 0.50 wt. %, or for example less than about 0.25 wt. %. The structure may be essentially free from tungsten, as may be achieved for example by using starting materials which are essentially free of tungsten. Tungsten content, measured as W₂O₃, may be measured by XRF.

In an embodiment, the amount of yttria, measured as Y₂O₃, is less than about 2.5 wt. %, for example, less than about 2.0 wt. %, for example, less than about 1.5 wt. %, for example, less than about 1 wt. %, for example, less than about 0.5 wt. %, for example, in the range of about 0.3-0.4 wt. %. Any yttria present may be derived from yttria-stabilized zirconia which in embodiments may be used as a source of zirconia. The structure may be essentially free from yttria, as may be achieved for example by using starting materials which are essentially free of yttria. Yttria content, measured as Y₂O₃, may be measured by XRF.

In an embodiment, the amount of rare earth metals, measured as Ln₂O₃ (wherein Ln represents any one or more of the lanthanide elements La, Ce, Pr, Nd, Pm, Sm, Eu, Gd, Tb, Dy, Ho, Er, Tm, Yb and Lu), is less than about 2 wt. %, and for example less than about 1 wt. %, or for example less than about 0.75 wt. %, or for example less than about 0.50 wt. %, or for example less than about 0.25 wt. %. The structure may be essentially free from rare earth metals, as may be achieved for example by using starting materials which are essentially free of rare earth metals. Rare earth content, measured as Ln₂O₃, may be measured by XRF.

The ceramic composition, for example, ceramic honeycomb structure, is typically porous having a porosity in the range of from about 30% to about 70%. In one embodiment, the porosity is from about 35% to about 65%, for example, from about 40% to about 65%, or from about 35% to about 60%, or from about 40% to about 60%. In a further embodiment, the porosity is from about 35% to about 50%, for example, from about 35% to about 45%, or from about 35% to about 40%, or from about 40% to about 45% (calculated on the basis of the total volume of the mineral phases and pore space). Pore space (e.g., total pore volume) may be determined by mercury diffusion as measured using a Thermo Scientific Mercury Porosimiter—Pascal 140, with a contact angle of 130 degrees, or any other measurement method which gives an equivalent result.

In certain embodiments, the ceramic composition has a pore size (d50) of from about 8.0 to 25.0 μm, for example, from about 10.0 to 20.0 microns, or from about 12.0 to 20.0 microns, or from about 13.0 to 20.0 μm, or from about 14.0 to 20.0 μm. Pore size may be determined by mercury porosimetry using a Pascal 140 series mercury porosimeter from Thermo Scientific (Thermo Fisher). The software employed is S.O.L.I.D. S/W, version 1.3.3 from Thermo Scientific. A sample weight of 1.0 g+/−0.5 g is typically used for this measurement.

In certain embodiments, the ceramic composition, e.g., ceramic honeycomb structure, exhibits favourable high temperature properties. For example, a mechanical strength property of the ceramic composition, e.g., ceramic honeycomb structure may increase at elevated temperatures, e.g., at a temperature of at least about 800° C. Put another way, a mechanical strength property of the ceramic composition, e.g., ceramic honeycomb structure, at elevated temperatures (e.g., at least about 800° C.) may be greater than the mechanical strength property of the ceramic composition at lower temperature, e.g., room temperature (e.g., about 25° C.).

In certain embodiments, the mechanical strength property is the nominal beam strength, S_{NB} (in MPa), which may be determined in accordance with the three-point flexure test described in ASTM C 1674-08, section 11.2. The nominal beam strength in a three point flexure test may be calculated using the standard 3-point flexure elastic beam formula as follows:

$${S}_{NB} ( 3 pt ) = \frac{3 PL}{2 {bd}^{2}} 3 \text{-} Point Blend$$

where:
P=breaking force (N),
L=outer (support) span (mm,
b=specimen width (mm), and
d=specimen thickness.

In certain embodiments, the S_{NB} of the ceramic composition, e.g., ceramic honeycomb structure, increases at elevated temperature, e.g., at a temperature of at least about 800° C., compared to the S_{NB} at room temperature (e.g., about 25° C.). In certain embodiments, the S_{NB} increases from between about 0.5 and 1.5 MPa at about room temperature to between about 2.5 and 3.5 MPa at about 800° C. In certain embodiments, the S_{NB} at about 800° C. is about 50% greater than the S_{NB} at room temperature, for example, at least about 100% greater, or at least about 125% greater, or at least about 150% greater, or at least about 175% greater, or at least about 200% greater, or at least about 225% greater, or at least about 250% greater. In certain embodiments, the S_{NB} at about 800° C. is from about 50% to about 250% greater than the S_{NB} at room temperature, for example, from about 100% to about 225% greater. In such embodiments, the ceramic composition may comprise greater than about 46 wt. % tialite, no more than about 44 wt. % mullite, from about 3.0-8.0 wt. % Zr-containing mineral phase, have a CTE of equal to or less than about 1.1×10⁻⁶° C.⁻¹, and a TSP of greater than about 150° C., for example, a TSP of equal to or greater than about 175° C., or equal to or greater than about 200° C. In such embodiments, the ceramic composition may comprise greater than about 56 wt. % tialite, no more than about 40 wt. % mullite, from about 1.5-8.0 wt. % Zr-containing mineral phase, for example, from about 1.5-5.0 wt. % Zr-containing mineral phase, or from about 1.5-3.5 wt. % Zr-containing mineral phase, have a CTE of equal to or less than about 1.1×10⁻⁶° C.⁻¹, and a TSP of greater than about 150° C., for example, a TSP of equal to or greater than about 175° C., or equal to or greater than about 200° C.

In certain embodiments, the S_{NB} increases from between about 0.5 and 1.5 MPa at about room temperature to between about 2.5 and 3.5 MPa at about 1300° C. In certain embodiments, the S_{NB} at about 1300° C. is about 50% greater than the SNB at room temperature, for example, at least about 100% greater, or at least about 125% greater, or at least about 150% greater, or at least about 175% greater, or at least about 200% greater, or at least about 225% greater, or at least about 250% greater. In certain embodiments, the S_{NB} at about 1300° C. is from about 50% to about 250% greater than the S_{NB} at room temperature, for example, from about 100% to about 225% greater.

The ceramic composition, for example, ceramic honeycomb structure, is formed by sintering a ceramic precursor composition, as described below.

### Ceramic Precursor Compositions

Unless otherwise stated, the amounts expressed in wt. % (or ‘weight %’ or ‘% by weight’) below are based on the total weight of inorganic mineral components in each of the ceramic precursor compositions, i.e., excluding solvent (e.g., water), binder, auxiliant, pore forming agents and any other non-inorganic mineral components.

The solid mineral compounds suitable for use as raw materials in the present invention (aluminosilicate, alumina, titania, tialite, mullite, chamotte, etc.) can be used in the form of powders, suspensions, dispersions, and the like. Corresponding formulations are commercially available and known to the skilled person in the art. For example, powdered andalusite having a particle size range suitable for the present invention is commercially available under the trade name Kerphalite (Damrec), powdered alumina and alumina dispersions are available from Evonik Gmbh or Nabaltec, and powdered titania and titania dispersions are available from Cristal Global.

The ceramic precursor composition suitable for sintering to form a ceramic composition according to first aspect of the invention comprises: mullite and/or one or more mullite-forming compounds or compositions; tialite and/or one or more tialite-forming compounds or compositions; and Zr-containing mineral phase and/or one or more Zr-containing mineral phase-forming compounds or compositions. The ceramic precursor composition may further comprise an alkaline earth metal-containing mineral phase and/or alkaline earth metal-containing mineral phase-forming compounds or compositions.

The relative amounts of: mullite and/or one or more mullite-forming compounds or compositions; tialite and/or one or more tialite-forming compounds or compositions; and Zr-containing mineral phase and/or one or more Zr-containing mineral phase-forming compounds or compositions (e.g., aluminosilicate, titania, alumina and zirconia) are selected such that upon sintering the ceramic precursor composition at a suitable temperature, e.g., above about 1400° C., or above about 1500° C., a ceramic composition or ceramic honeycomb structure according to the first aspect and second aspects of the present invention is obtained.

The mullite and/or one or more mullite-forming compounds or compositions, and tialite and/or one or more tialite-forming compounds or compositions may be selected from mullite, tialite, aluminosilicate, titania and alumina.

The aluminosilicate may be selected from one or more of andalusite, kyanite, sillimanite, mullite, molochite, a hydrous kandite clay such as kaolin, halloysite or ball clay, or an anhydrous (calcined) kandite clay such as metakaolin or fully calcined kaolin. In further embodiments, the aluminosilicate is selected from one or more of andalusite and kaolin. In a further embodiment, the aluminosilicate is andalusite.

In a further embodiment, the aluminosilicate, for example andalusite, is present in the ceramic precursor composition in the form of particles present in a size in the range between 0.1 μm and 55 μm, or between 0.1 μm and 80 μm, or between 10 μm and 55 μm, or between 10 μm and 75 μm, or between 15 μm and 55 μm, or between 15 μm and 75 μm, or between 20 μm and 55 μm, or between 20 μm and 75 μm. In a further embodiment, the aluminosilicate, for example andalusite, is in the form of particles having a size in the range between 0.1 μm and 125 μm, or between 0.1 μm and 100 μm, or between 0.1 μm and 75 μm, or between 25 μm and 100 μm, or between 25 μm and 75 μm.

The titania may be selected from one or more of rutile, anatase, brookite.

The zirconia may be selected from one or more of ZrO₂ and TiₓZr₁₋ₓO₂ (as described above). Besides the advantageous effects the presence of Zr-containing mineral phase in the ceramic composition can have on thermomechanical properties of the sintered ceramic composition, the inclusion of ZrO₂ in the ceramic precursor composition appears to enhance the reactivity of alumina, such that the alumina content of the final sintered ceramic can be reduced or eliminated. Further, the inclusion of ZrO₂ may facilitate primary and secondary mullitization at lower reaction temperatures.

In embodiments, the alumina is selected from one or more of fused alumina (e.g., corundum), sintered alumina, calcined alumina, reactive or semi-reactive alumina, and bauxite.

In a further embodiment, the alumina is present in the form of particles having a size in the range between 0.1 to 150 μm, or in the range between 0.1 to 100 μm or in the range between 0.1 to 75 μm, or in the range between 0.1 to 50 μm, or in the range between 0.1 to 25 μm, or in the range between 0.1 to 10 μm, or in the range between 0.1 to 1 μm, or between 0.3 to 0.6 μm. In a further embodiment, the alumina is used in the form of colloidal/nanometric solutions.

In all of the above embodiments comprising the use of alumina (Al₂O₃), titania (TiO₂) and zirconia (ZrO₂), the alumina, titania and/or zirconia may be partially or fully replaced by alumina, titania and/or zirconia precursor compounds. By the term “alumina precursor compounds”, such compounds are understood which may comprise one or more additional components to aluminum (Al) and oxygen (O), which additional components are removed during subjecting the alumina precursor compound to sintering conditions, and wherein the additional components are volatile under sintering conditions. Thus, although the alumina precursor compound may have a total formula different from Al₂O₃, only a component with a formula Al₂O₃ (or its reaction product with further solid phases) is left behind after sintering. Thus, the amount of alumina precursor compound present in an extrudable mixture or green honeycomb structure according to the invention can be easily recalculated to represent a specific equivalent of alumina (Al₂O₃). The terms “titania precursor compound” and “zirconia precursor compound” are to be understood in similar fashion.

Examples for alumina precursor compounds include, but are not limited to aluminum salts such as aluminum phosphates, and aluminum sulphates, or aluminum hydroxides such as boehmite (AlO(OH) and gibbsite (Al(OH)₃). The additional hydrogen and oxygen components present in those compounds are set free during sintering in the form of water. Usually, alumina precursor compounds are more reactive in solid phase reactions occurring under sintering conditions, than alumina (Al₂O₃) itself. Moreover, several of the alumina precursor compounds are available in preparations showing very small particle sizes, which also leads to an increased reactivity of the particles under sintering conditions.

The aluminosilicate and in (part) alumina are the main mullite-forming components of the ceramic precursor composition. During primary mullitization, aluminosilicate decomposes and mullite forms. In secondary mullitization, excess silica from the aluminosilicate reacts with any remaining alumina, forming further mullite. As described below, the ceramic precursor composition may be sintered to a suitably high temperature, for example, between about 1500° C. and 1600° C., e.g., between about 1525 and 1575° C., such that substantially all aluminosilicate and alumina has been consumed in the primary and secondary mullitization stages.

Alumina and titania are the main tialite-forming components of the ceramic precursor composition. In certain embodiments, the alumina is present in the form of particles having a size in the range between 0.1 to 150 μm, or in the range between 0.1 to 100 μm or in the range between 0.1 to 75 μm, or in the range between 0.1 to 50 μm, or in the range between 0.1 to 25 μm, or in the range between 0.1 to 10 μm, or between 0.1 to 1 μm, or between 0.3 to 0.6 μm. In a further embodiment, the alumina is used in the form of colloidal/nanometric solutions. In a further embodiment, the titania is present in the form of particles having a size in the range between 0.1 to 100 μm, or in the range between 0.1 to 50 μm, or in the range between 0.1 to 10 μm, or between 0.1 to 1 μm, or between 0.3 to 50 μm, or between 0.3 to 1 μm, or between 0.3 to 0.6 μm. In a further embodiment, the titania is present in the form of particles having a size in the range between 0.1 to 10 μm, or between 0.2 to 1 μm, or between 0.2 to 0.5 μm. In a further embodiment, the titania is used in the form of colloidal/nanometric solutions. Where colloidal titania is used, this may be employed together with a non-colloidal form of titania, for example one having a d₅₀ smaller than 1 μm, for example a d₅₀ smaller than 0.5 μm. In a further embodiment, the size of the titania particles is larger than the size of the alumina particles. In a further embodiment, the amount of the alumina in the ceramic precursor composition is higher than the amount of titania.

Because the components of the ceramic precursor composition may have different particle size ranges, the ceramic precursor composition may have a bimodal or multimodal particle size distribution. In other embodiments, particle size ranges of components may be selected such that the ceramic precursor composition has a monomodal particle size distribution. In further embodiments, the ceramic precursor composition may be subjected to size classification step, for example, by milling or sieving, prior to a forming step (e.g., extrusion) to homogenize the mixture particle size distribution, e.g., milling to obtain a ceramic precursor composition having a monomodal particle size distribution.

In certain embodiments, the ceramic precursor composition comprises an amount of alkaline earth metal oxide or alkaline earth metal oxide precursor, or combinations thereof. The alkaline earth metal oxide may be magnesium oxide, calcium oxide, barium oxide, or combinations thereof. The alkaline earth metal oxide precursor may be an alkaline earth metal salt, for example, an alkaline earth metal sulphide, sulphate, chloride, nitrate or carbonate, in which the alkaline earth metal may be magnesium, strontium, calcium, barium or combinations thereof. In certain embodiments, the alkaline earth metal oxide precursor is an alkaline earth metal carbonate, which may be magnesium carbonate, strontium carbonate, calcium carbonate, barium carbonate or mixtures thereof. In embodiments, the carbonate is magnesium or calcium carbonate, or combinations thereof. In an advantageous embodiment, the carbonate is magnesium carbonate. The amount of alkaline earth metal oxide and/or alkaline earth metal oxide precursor, for example, magnesium carbonate, may be from about 1-4 wt. %, based on the total weight of the ceramic precursor composition.

Thus, in certain embodiments, the ceramic precursor composition comprises (weight %):
15-55%, or 20-50%, or 20-45%, or 20-40%, or 25-40%, or 30-50%, or 25-35%, or 30-40%, or 40-50%, or 35-45% aluminosilicate;
15-35%, or 20-30%, or 22-27% titania;
25-45%, or 30-45%, or 35-40%, or 30-40%, or 35-45%, 37-45%, or 40-45% alumina;
1.0-8.0%, or 1.5-8.0%, or 2.0-8.0%, or 2.5-8.0%, or 3.0-8.0%, or 3.0-7.0%, or 3.5-7.0%, or 3.5-6.5%, or 3.5-6.0%, or 3.5-5.5%, or 4.0-6.0%, or 4.0-5.0% zirconia and/or zirconium titanate; and
0-10%, or 0.5-8%, or 0.5-7%, or 1.0-6.0%, or 1.5-5.5%, 2.0-5.0%, or 2.5-5.0%, or 3.0-5.0%, or 3.5-5.0% alkaline earth metal oxide and/or alkaline earth metal oxide precursor.

In a further embodiment, the ceramic precursor compositions of the present invention comprises a pore former, for example, a graphite component. The pore former, for example, graphite, can be present in an amount of up to about 55% (based on the total weight of the inorganic mineral components), for example, from about 1 to about 40 wt. %, or from about 1 to about 25 wt. %, or from about 5 to about 20 wt. %, or from about 5 to about 15 wt. %, or form about 5 to about 10 wt. %, or from about 10 to about 20 wt. %, or from about 10 to about 15 wt. %. The pore former, for example, graphite material, can be used in a particulate form, wherein the particles have a size of less than 200 μm, or less than 150 μm, or less than 100 μm. In another embodiment, the graphite particles have a median particle diameter (d₅₀) between 0 and 100 μm; or between 5 μm to 50 μm, or between 7 μm and 30 μm, or between 20 μm and 30 μm. The graphite may be included as a pore former, as described below.

In certain embodiments, the ceramic precursor composition comprises preformed mullite, for example, a mullite-containing chamotte, and tialite-forming precursor components, i.e., titania and alumina, and the zirconia precursor, and optionally one or more of aluminosilicate and alkaline earth metal carbonate. In an embodiment, the preformed-mullite is a mullite-containing chamotte, for example, a chamotte comprising at least about 90 wt. % mullite, or at least about 95 wt. % mullite, or at least about 99 wt. % mullite, or consisting essentially of 100 wt. % mullite.

Thus, in certain embodiments, the ceramic precursor composition comprises (weight %):
from about 15% to less than about 50%, or 25-49%, or 30-48%, or 35-47%, or 35-46%, or 35-45%, or 36-45%, or 37-45%, or 37-44%, or 37-43%; or 35-43%, or 35-42%, or 35-41%, or 35-40%, or 40-48%, or 40-45% mullite-containing chamotte;
from about 15-35%, or 20-35%, or 18-30%, or 20-28, or 20-25 titania or titania precursor;
from about 15-35%, or 20-35%, or 20-30%, or 22-30%, 22-28% alumina;
1.0-8.0%, or 1.5-8.0%, or 2.0-8.0%, or 2.5-8.0%, or 3.0-8.0%, or 3.0-7.0%, or 3.5-7.0%, or 3.5-6.5%, or 3.5-6.0%, or 3.5-5.5%, or 4.0-6.0%, or 4.0-5.0% zirconia and/or zirconium titanate; and
0-10%, or 0.5-8%, or 0.5-7%, or 1.0-6.0%, or 1.5-5.5%, 2.0-5.0%, or 2.5-5.0%, or 3.0-5.0%, or 3.5-5.0% alkaline earth metal oxide and/or alkaline earth metal oxide precursor.

Generally, the amount of titania will be such that, upon sintering at a suitable temperature, e.g., above about 1400° C., or above about 1500° C., the titania and alumina (and any additional alumina present in a mullite-containing chamotte) form a tialite mineral phase which constitutes from about 40 wt % to less than about 75 wt %, for example, from about 45 wt. % to about 60 wt. %, of the ceramic composition or ceramic honeycomb structure obtained following sintering. The person skilled in the art will be able to determine suitable raw materials, amounts and sintering temperature depending on the desired composition of the mullite-containing chamotte. Suitable raw materials include aluminosilicate (including the types described above), alumina (including types described above), titania (including the types described above), zirconia (including the types described above) and alkaline earth metal oxide and/or alkaline earth metal oxide precursor (including the types described above).

In certain embodiments, the relative amounts of mullite, e.g., mullite-containing chamotte, titania and alumina, zirconia and optional aluminosilicate and alkaline earth metal oxide/carbonate, are selected such that upon sintering the ceramic precursor composition at a suitable temperature, e.g., above about 1400° C., or above about 1500° C., a ceramic composition or ceramic honeycomb structure according to the first aspect and second aspects of the present invention is obtained.

The binding agents and auxiliants that may be used in the present invention are all commercially available from various sources known to the skilled person in the art. The function of the binding agent is to provide a sufficient mechanical stability of the green honeycomb structure in the process steps before the heating or sintering. The additional auxiliants provide the raw material, i.e., ceramic precursor composition, with advantageous properties of the extrusion step (e.g., plasticizers, glidants, lubricants, and the like).

In embodiments, the ceramic precursor composition (or the extrudable mixture or green honeycomb structure formed therefrom) comprises one or more binding agents selected from the group consisting of, methyl cellulose, hydroxymethylpropyl cellulose, polyvinyl butyrals, emulsified acrylates, polyvinyl alcohols, polyvinyl pyrrolidones, polyacrylics, starch, silicon binders, polyacrylates, silicates, polyethylene imine, lignosulfonates, and alginates.

In a further embodiment, the ceramic precursor composition (or the extrudable mixture or green honeycomb structure formed therefrom) comprises one or more mineral binders. Suitable mineral binder may be selected from the group including, but not limited to, one or more of bentonite, aluminum phosphate, boehmite, sodium silicates, boron silicates, or mixtures thereof.

The binding agents can be present in a total amount between about 0.5 and 20%, for example, from about 0.5% and 15%, or between about 2% and 9% (based on the total weight of inorganic mineral components in the ceramic precursor composition or extrudable mixture or the green honeycomb structure).

In a further embodiment, the ceramic precursor composition (or the extrudable mixture or green honeycomb formed therefrom) comprises one or more auxiliants (e.g. plasticizers and lubricants) selected from the groups consisting of polyethylene glycols (PEGs), glycerol, ethylene glycol, octyl phthalates, ammonium stearates, wax emulsions, oleic acid, Manhattan fish oil, stearic acid, wax, palmitic acid, linoleic acid, myristic acid, and lauric acid.

The auxiliants can be present in a total amount between about 0.5% and about 40%, for example, from about 0.5% to about 30%, or from about 0.5% and about 25%, or from about 0.5% and about 15%, or between 2% and 9% (based on the total weight of inorganic mineral components in the ceramic precursor composition or extrudable mixture or the green honeycomb structure).

Each of the ceramic precursor compositions may be combined with solvent. The solvent may be an organic or aqueous liquid medium. In certain embodiments, the solvent is water. The solvent, e.g., water, may be present in an amount ranging from about 1-55 wt. %, based on the total weight of inorganic mineral components in the ceramic precursor composition, for example, from about 5 to about 40 wt. %, or from about 10 to about 35 wt. %, or from about 15 to about 30 wt. %, or from about 20 to about 30 wt. %, or from about 22 to about 28 wt. %.

Each of the ceramic precursor compositions of the present invention may further comprise an amount of pore former. The pore former is any chemical entity which, when included in the ceramic precursor composition, induces or otherwise facilitates the creation of porosity in the ceramic composition formed by sintering the ceramic precursor composition. Suitable pore formers include graphite (as described above) or other forms of carbon, cellulose and cellulose derivatives, starch, organic polymers and mixtures thereof. Pore former may be present in an amount ranging from about 1 and 70 wt. %, based on the total weight of inorganic mineral components in the ceramic precursor composition, for example, from about 1 to about 60 wt. %, or from about 1 to about 50 wt. %, or from about 1 to about 40 wt. %, or from about 1 to about 30 wt. %, or from about 2 to about 25 wt. %, or from about 2 to about 20 wt. %, or from about 2 to about 15 wt. %, or from about 4 to about 12 wt. %, or from about 4 to about 10 wt. %, or from about 5 to about 8 wt. %.

### Preparative Methods

The preparation of an extrudable mixture from the mineral compounds, i.e., the ceramic precursor composition (optionally in combination with binding agent(s), mineral binder(s) and/or auxiliant(s)) is performed according to methods and techniques known in the art. For, example, the components of the ceramic precursor composition can be mixed in a conventional kneading machine with the addition of a suitable amount of a suitable liquid phase as needed (normally water) to a slurry or paste suitable for extrusion. Additionally, conventional extruding equipment (such as, e.g., a screw extruder) and dies for the extrusion of honeycomb structures known in the art can be used. A summary of the technology is given in the textbook of W. Kollenberg (ed.), Technische Keramik, Vulkan-Verlag, Essen, Germany, 2004, which is incorporated herein by reference.

The diameter of the green honeycomb structures can be determined by selecting extruder dies of desired size and shape. After extrusion, the extruded mass is cut into pieces of suitable length to obtain green honeycomb structures of desired format. Suitable cutting means for this step (such as wire cutters) are known to the person skilled in the art.

The extruded green honeycomb structure can be dried according to methods known in the art (e.g., microwave drying, hot-air drying) prior to sintering.

The dried green honeycomb structure is then heated in a conventional oven or kiln for preparation of ceramic materials. Generally, any oven or kiln that is suitable to subject the heated objects to a predefined temperature is suitable for the process of the invention.

In certain embodiments, the green honeycomb structure maybe plugged prior to sintering. In other embodiments, the plugging may be carried out after sintering. Further details of the plugging process are described below.

When the green honeycomb structure comprises organic binder compound and/or organic auxiliants, usually the structure is heated to a temperature in the range between 200° C. and 400° C., for example, between about 200° C. and 300° C., prior to heating the structure to the final sintering temperature, and that temperature is maintained for a period of time that is sufficient to remove the organic binder and auxiliant compounds by means of combustion (for example, between one and three hours). For example, one heating program for the manufacture of ceramic honeycomb structures of the present invention is as follows:
heating from ambient temperature to 250° C. with a heating rate of 0.5° C./min;
maintaining the temperature of 250° C. for up to about two hours;
heating to the final sintering temperature with a heating rate of 2.0° C./min; and
maintaining the final sintering temperature for about 1 hour to about four hours.

The honeycomb structure may be sintered at a temperature in the range from between 1200° C. and 1700° C., or between about 1250° C. and 1650° C., or between about 1350° C. and 1650° C., or between 1400° C. and 1600° C., or between about 1450° C. and 1600° C., or between about 1500° C. and 1600° C. In certain embodiments, the sintering step is performed at temperature between about 1520° C. and 1600° C., or between about 1530° C. and 1600° C., or between about 1540° C. and 1600° C., or between about 1550° C. and 1600° C., or between about 1525° C. and about 1575° C. In certain embodiments, the sintering temperature is less than about 1575° C.

For embodiments of the invention in which the ceramic precursor composition comprises a major amount of mullite-forming components/compositions and tialite-forming components compositions, e.g., a ceramic precursor composition according to the third aspect of the invention, the above components/compositions undergo chemical reactions resulting in the formation of mullite and tialite. These reactions, as well as the required reactions conditions, are known to persons skilled in the art. A summary is given in the textbook of W. Kollenberg (ed.), Technische Keramik, Vulkan-Verlag, Essen, Germany, 2004, which is incorporated herein by reference.

For embodiments in which at least part of the mullite and tialite are already formed in the ceramic precursor composition, the number of competing reactions during sintering is reduced and comprise substantially only primary and secondary mullitization. A further advantage in using a precursor composition comprising already formed mullite and tialite is better control of the amounts of these mineral phases in the sintered ceramic composition or honeycomb structure.

Sintering may be performed for a suitable period of time and a suitable temperature such that the mullite and tialite mineral phases constitute at least about 80% of the total weight of the mineral phases, for example, at least about 85% of the total weight of the mineral phases, or at least about 90% of the total weight of the mineral phases, or at least about 92% of the total weight of the mineral phases, or at least about 94%, or at least about 96%, or at least about 97%, or at least about 98%, or at least about 99% of the total weight of the mineral phases, or up to about 98.5 wt. % of the mineral phases, or up to about 98.0 wt. % of the mineral phases, or up to about 97.5% of the mineral phases, or up to about 97.0% of the mineral phases, or up to about 96.5% of the mineral phases, or up to about 96.0% of the mineral phases, or up to about 95.5% of the mineral phases, or up to about 95.0% of the mineral phases.

### Ceramic Honeycomb Structures:

In the ceramic honeycomb structures described in the above embodiments, the optimal pore diameter is in the range between 5 to 30 μm, or 10 to 25 μm. Depending on the intended use of the ceramic honeycombs, in particular with regard to the question whether the ceramic honeycomb structure is further impregnated, e.g., with a catalyst, the above values may be varied. For non-impregnated ceramic honeycomb structures, the pore diameter is usually in the range between 7 and 15 μm, while for impregnated structures, the range is usually between 10 and 25 μm prior to impregnating, for example, between 15 and 25 μm, or between about 20 and 25 μm prior to impregnating. The catalyst material deposited in the pore space will result in a reduction of the original pore diameter.

The honeycomb structure of the invention can typically include a plurality of cells side by side in a longitudinal direction that are separated by porous partitions and plugged in an alternating (e.g., checkerboard) fashion. In one embodiment, the cells of the honeycomb structure are arranged in a repeating pattern. The cells can be square, round, rectangular, octagonal, polygonal or any other shape or combination of shapes that are suitable for arrangement in a repeating pattern. Optionally, the opening area at one end face of the honeycomb structural body can be different from an opening area at the other end face thereof. For example, the honeycomb structural body can have a group of large volume through-holes plugged so as to make a relatively large sum of opening areas on its gas inlet side and a group of small volume through-holes plugged so as to make a relatively small sum of opening areas on its gas outlet side.

In certain embodiments, the cells of the honeycomb structure are arranged in accordance with the structures described in WO-A-2011/117385, the entire contents of which are hereby incorporated by reference.

An average cell density of the honeycomb structure of the present invention is not limited. The ceramic honeycomb structure may have a cell density between 6 and 2000 cells/square inch (0.9 to 311 cells/cm²), or between 50 and 1000 cells/square inch (7.8 to 155 cells/cm²), or between 100 and 400 cells/square inch (15.5 to 62.0 cells/cm²).

The thickness of the partition wall separating adjacent cells in the present invention is not limited. The thickness of the partition wall may range from 100 to 500 microns, or from 200 to 450 microns.

Moreover, the outer peripheral wall of the structure is preferably thicker than the partition walls, and its thickness may be in a range of 100 to 700 microns, or 200 to 400 microns. The outer peripheral wall may be not only a wall formed integrally with the partition wall at the time of the forming but also a cement coated wall formed by grinding an outer periphery into a predetermined shape.

In certain embodiments, the ceramic honeycomb structure is of a modular form in which a series of ceramic honeycomb structures are prepared in accordance with the present invention and then combined to form a composite ceramic honeycomb structure. The series of honeycomb structures may be combined whilst in the green state, prior to sintering or, alternatively, may be individually sintered, and then combined. In certain embodiments, the composite ceramic honeycomb structure may comprise a series of ceramic honeycomb structures prepared in accordance with present invention and ceramic honeycomb structures not in accordance with the present invention.

For the use as diesel particulate filters, the ceramic honeycomb structures of the present invention, or the green ceramic honeycomb structures of the present invention can be further processed by plugging, i.e., close certain open structures of the honeycomb at predefined positions with additional ceramic mass. Plugging processes thus include the preparation of a suitable plugging mass, applying the plugging mass to the desired positions of the ceramic or green honeycomb structure, and subjecting the plugged honeycomb structure to an additional sintering step, or sintering the plugged green honeycomb structure in one step, wherein the plugging mass is transformed into a ceramic plugging mass having suitable properties for the use in diesel particulate filters. It is not required that the ceramic plugging mass is of the same composition as the ceramic mass of the honeycomb body. Generally, methods and materials for plugging known to the person skilled in the art may be applied for the plugging of the honeycombs of the present invention. In an exemplary process about 50% of the inlet channels are plugged on one side of the honeycomb piece and on the opposite side a further 50% of the channels are plugged in order such that, in use, exhaust gas is forced to pass through walls of the honeycomb structure.

The plugged ceramic honeycomb structure may then be fixed in a box suitable for mounting the structure into the exhaust gas line of a diesel engine, for example, the diesel engine of a vehicle (e.g., automobile, truck, van, motorbike, digger, excavator, tractor, bulldozer, dump-truck, and the like).

### EXAMPLES

### Example 1

A series of ceramic honeycomb structures were obtained from the ceramic precursor compositions described in Tables 1 and 2 below. Compositional analysis and thermomechanical properties were determined in accordance with the methods described above. Results are summarised in Tables 3-6.

Samples RMT1-RMT4 were extruded as square honeycomb barrels and fired in a laboratory electric kiln at a maximum temperature of 1550° C. (1 hour soaking time). Samples RMT5-RMT9 were extruded as complete honeycomb prototypes and fired in an industrial gas kiln at a maximum temperature of 1550° C. (2 hour soaking time)

TABLE 1

| | RMT1 | RMT2 | RMT3 | RMT4 | RMT5 |
|---|---|---|---|---|---|
| Raw materials | (wt. %) | (wt. %) | (wt. %) | (wt. %) | (wt. %) |
| Aluminosilicate | 33.2% | 33.3% | 33.5% | 33.7% | 33.1% |
| precursor | | | | | |
| Tialite precursor | 24.2% | 24.4% | 24.5% | 24.6% | 24.2% |
| Alumina | 36.3% | 36.5% | 36.7% | 36.8% | 36.2% |
| Zirconia precursor | 5.0% | 4.6% | 4.0% | 3.6% | 5.2% |
| Mg Precursor | 1.2% | 1.3% | 1.3% | 1.3% | 1.2% |
| Total solid content | 100.0% | 100.0% | 100.0% | 100.0% | 100.0% |
| Water and binders | 37.3% | 37.3% | 37.3% | 37.3% | 42.2% |
| Total | 137.3% | 137.3% | 137.3% | 137.3% | 142.2% |

TABLE 2

| | RMT 6 | RMT 7 | RMT 8 | RMT 9 |
|---|---|---|---|---|
| Raw materials | (wt. %) | (wt. %) | (wt. %) | (wt. %) |
| Aluminosilicate precursor | 25.44% | 22.55% | 19.10% | 26.61 |
| Tialite precursor | 28.52% | 30.37% | 32.72% | 27.69 |
| Alumina | 42.2% | 43.2% | 44.3% | 41.9 |
| Zirconia precursor | 2.60% | 2.60% | 2.60% | 2.60 |
| Mg Precursor | 1.24% | 1.24% | 1.24% | 1.25 |
| Total solid content | 100.0% | 100.0% | 100.0% | 100.0 |
| Water and binders | 39.84% | 39.84% | 39.84% | 40.06 |
| Total | 139.8% | 139.8% | 139.8% | 140.1 |

TABLE 3

| Recipe | | RMT1 | RMT2 | RMT3 | RMT4 | RMT5 |
|---|---|---|---|---|---|---|
| Zirconia precursor (% weight) | | 5.0% | 4.6% | 4.0% | 3.6% | 5.2% |
| XRD (measured) | % tialite | 51% | 50% | 55% | 50% | 52% |
| Porosity | (%) | 48.2% | 47.5% | 46.2% | 47.4% | 37.2% |
| CTE (800° C.) | (10E−6° C.⁻¹) | 0.9 | 1 | 1.3 | 1.4 | 0.9 |

TABLE 4

| Recipe | | RMT 6 | RMT 7 | RMT 8 | RMT 9 |
|---|---|---|---|---|---|
| TiO₂ precursor (% weight) | | 25.4% | 22.6% | 19.1% | 27.7% |
| XRD (measured) | % tialite | 61% | 66% | 72% | 60% |
| Porosity | (%) | 42% | 43% | 43% | 47% |
| CTE (800° C.) | (10E−6° C.⁻¹) | 1.1 | 0.8 | 0.7 | 1.0 |

TABLE 5

| | Recipe | | RMT5 |
|---|---|---|---|
| Zirconia precursor (% weight) | | | 5.2% |
| | Porosity | (%) | 37.2% |
| | Pore size (d50) | (microns) | 17.9 |
| | MOR* (S_{NB}) | (MPa) | 1.9 |
| | CTE (800° C.) | (10E−6° C.⁻¹) | 0.9 |
| | Young Modulus | (GPa) | 9.6 |
| | TSP | ° C. | 220 |

*4-point test

TABLE 6

| Recipe | | RMT6 | RMT7 | RMT8 | RMT 9 |
|---|---|---|---|---|---|
| Tialite precursor (% weight) | | 28.5% | 30.4% | 32.7% | 27.7% |
| Porosity | (%) | 41.5% | 42.9% | 43.0% | 47% |
| Pore size (d50) | (microns) | 14.7 | 12.4 | 13.4 | 17.7 |
| MOR (S_{NB}) | (MPa) | 1.5 | 1.2 | 0.9 | 0.6 |
| CTE (800° C.) | (10E−6° | 1.1 | 0.8 | 0.7 | 1.0 |
| | C.⁻¹) | | | | |
| Young Modulus | (GPa) | 7.8 | 7.9 | 6.3 | 3.0 |
| TSP | ° C. | 175 | 190 | 204 | 200 |

### Example 2

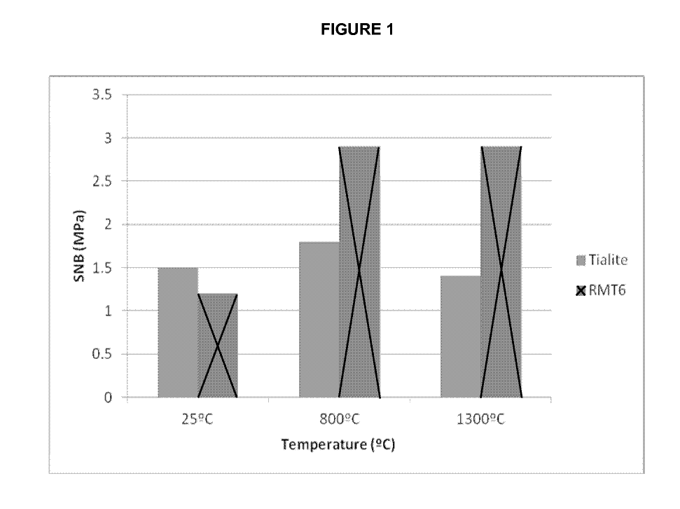

The nominal beam strength, S_{NB} (in MPa), of sample RMT 6 was determined in accordance with the three-point flexure test described in ASTM C 1674-08, section 11.2 (as described above) between 25° C. and 1300° C. In the same way, a comparative sample formed of tialite was analysed. Results are summarized in FIG. 1. It is seen that S_{NB} for RMT-6 increases significantly at elevated temperatures, whereas there is little variation in S_{NB} of the tialite honeycomb.

1. A ceramic composition comprising:
from about 15 wt. % to less than about 50 wt. % mullite;
from about 40 wt. % to about 75 wt. % tialite; and
at least about 1.0 wt. % of a Zr-containing mineral phase;
wherein the weight ratio of tialite to mullite is greater than 1:1, and
wherein the ceramic composition has a coefficient of thermal expansion (CTE) of equal to or less than about 1.5×10⁻⁶° C.⁻¹, and a thermal strength parameter (TSP) of at least about 150° C.

2. A ceramic composition according to claim 1, wherein the ceramic composition comprises from about 40 wt. % to about 55 wt. % tialite.

3. A ceramic composition according to claim 1 wherein the ceramic composition has a CTE of less than about 1.5×10⁻⁶° C.⁻¹ and a TSP of at least about 170° C.

4. A ceramic composition according to claim 1, wherein the ceramic composition comprises from about 1.0 wt. % to about 8 wt. % of the Zr-containing mineral phase.

5. A ceramic composition according to claim 4, wherein the ceramic composition comprises from about 45 wt. % to about 55 wt. % tialite and from about 3.0 wt. % to about 8.0 wt. % of the Zr-containing mineral phase.

6. A ceramic composition according to claim 1, wherein the Zr-containing phase comprises at least about 20 wt. % zirconium titanate.

7. A ceramic composition according to claim 1, further comprising from about 0.5 wt. % to about 8 wt. % of an alkaline earth metal-containing mineral phase.

8. A ceramic composition according to claim 1, wherein: (i) a nominal beam strength, S_{NB}, of the ceramic composition increases at elevated temperatures and (ii) the S_{NB} of the ceramic composition at about 800° C. is greater than the S_{NB} of the ceramic composition at about 25° C.

9. A ceramic composition according to claim 1 wherein the ceramic composition comprises from about 55 wt. % to about 70 wt % tialite.

10. A ceramic composition according to claim 1, wherein the ceramic composition is in the form of a honeycomb structure.

11. A ceramic precursor composition suitable for sintering to form a ceramic composition according to claim 1, said precursor composition comprising:
mullite and/or one or more mullite-forming compounds or compositions;
tialite and/or one or more tialite-forming compounds or compositions; and
Zr-containing mineral phase and/or one or more Zr-containing mineral phase-forming compounds or compositions.

12. A ceramic precursor composition according to claim 11, further comprising an alkaline earth metal-containing mineral phase and/or alkaline earth metal-containing mineral phase-forming compounds or compositions.

13. A ceramic precursor composition according to claim 11, further comprising:
(i) one or more binding agents;
(ii) one or more mineral binders;
(iii) one or more pore forming agents;
(iv) one or more auxiliants; and/or
(v) water.

14. A method for making a honeycomb structure, said method comprising:
(a) providing a dried green honeycomb structure formed from the ceramic precursor composition according to any one of claims 11-13; and
(b) sintering.

15. A method according to claim 14, further comprising the steps of:
(a)(i) providing an extrudable mixture formed from the ceramic precursor composition;
(a)(ii) extruding the mixture to form a green honeycomb structure;
(a)(iii) drying the green honeycomb structure; and
(b) sintering at a temperature of from about 1200° C. to about 1700° C.

16. A method according to claim 14, further comprising plugging the green honeycomb structure or sintered honeycomb structure.

17. A diesel particulate filter comprising the ceramic honeycomb structure of claim 10.

18. A vehicle having a diesel engine and a filtration system comprising the diesel particulate filer according to claim 17.

19. A ceramic composition according to claim 4, wherein composition comprises from about 56 wt, % to about 75 wt. % tialite and from about 1.5 wt. % to about 5.0 wt. % of the Zr-containing mineral phase.

20. A ceramic composition according to claim 7, wherein the alkaline earth metal-containing mineral phase is a Mg-containing mineral phase.
